(19) United States
(12) Patent Application Publication
(10) Pub. No.: US 2019/0240776 A1
(43) Pub. Date: Aug. 8, 2019

(54) Method for Efficient Laser Cutting Based on Surface Darkening

(71) Applicant: Petro Kondratyuk, Pittsburg, PA (US)

(72) Inventor: Petro Kondratyuk, Pittsburg, PA (US)

(21) Appl. No.: 16/266,157

(22) Filed: Feb. 4, 2019

Related U.S. Application Data
(60) Provisional application No. 62/626,322, filed on Feb. 5, 2018.

(51) Int. Cl. B23K 26/12; B23K 26/18; B23K 26/38

(52) U.S. Cl. CPC B23K 26/126; B23K 26/38; B23K 26/18

(57) ABSTRACT

A method of laser cutting with improved efficiency for reflective and transparent materials is described. The method improves the absorption of the laser beam in the material being cut. Laser cutting is typically performed with a flow of a high pressure gas, termed assist gas, directed at the cutting point. Per this invention, a gaseous additive is added into the flow of the assist gas. The additive decomposes or reacts when it comes into contact with the hot laser-irradiated surface of the material and leaves a residue of elemental carbon (such as soot) on the surface. The residue of elemental carbon has excellent beam absorption characteristics and serves to efficiently transfer the energy from the laser beam to the material, thus enabling higher cutting speeds and greater maximum material thicknesses for the same laser optical power.

### CROSS-REFERENCE TO RELATED APPLICATIONS

62/626,322

### FEDERALLY SPONSORED RESEARCH

None

### SEQUENCE LISTING

None

### FIELD OF THE INVENTION

This invention pertains to laser cutting of metal and non-metal materials, and in particular, to the methods of laser cutting that employ an assist gas.

### SUMMARY OF THE INVENTION

A method of laser cutting having improved efficiency is presented. The method addresses the problem of poor laser beam absorption in the material being cut. Laser cutting is conventionally performed with a simultaneous flow of a high pressure gas, termed assist gas, directed at the cutting point. In accordance with the present invention, a gaseous carbon-containing additive is introduced into the flow of the assist gas. The additive is selected so that it decomposes or reacts when it comes into contact with the hot laser-irradiated surface of the material and leaves a residue of elemental carbon on the surface. The purpose of the additive is thus to darken the surface in the area where it is irradiated by the laser, thereby improving laser beam absorption.

Volatile or gaseous organic compounds are one class of such additives. Small quantities of acetylene, ethylene, propene or toluene (as a vapor) can be added to an inert nitrogen assist gas flow; these compounds decompose on the hot laser-irradiated surface of the metal forming black soot. The deposited soot has excellent beam absorption properties for all industrially used laser types, and efficiently transfers the energy from the laser beam to the material surface, thus allowing faster cutting speeds, higher maximum material thickness and enabling lower-powered lasers to be used in cutting.

### BACKGROUND OF THE INVENTION

Laser cutting of metal and non-metal materials has experienced substantial growth in the industry and manufacturing in the last two decades. This growth was driven by the increased availability of high-power laser sources (mostly CO₂ and fiber-based lasers), as well as the advantages that laser cutting possesses over competing technologies such as plasma or waterjet cutting. These advantages include high cutting speeds (particularly for thin metal sheets), excellent edge quality, narrow cut width, small extent of the heat-affected zone, and high cutting precision.

However, one disadvantage associated with laser cutting is the significant initial cost of the equipment, a large part of which is due to the cost of the high-power laser sources themselves. Since laser source costs tend to scale with the output power, there exists a significant economic incentive to achieve the same cutting speeds, or the same cutting thicknesses, with lasers of lower optical power.

It is known that the reflectivity of the material is an important factor influencing the cutting process. Metals such as copper and aluminum, as well as their alloys, can reflect as much as 95-98% of the laser beam directed at the surface at room temperature. Therefore only as little as 2% of the incident power is converted into the useful heat that causes the localized melting of the metal during cutting. Consequently, laser cutting of these materials requires excessively high laser power densities and suffers from slower cutting speeds and lower maximum material thicknesses. At the same time, these metals are of high industrial and manufacturing importance, which necessitates an improved method for their laser cutting.

A similar problem occurs with materials that are largely transparent to the laser beam. For example, if one attempts to cut a clear glass sheet with an industrial fiber laser operating at wavelengths of 1030-1100 nm, most of the incident laser power will pass through the glass sheet and not contribute to the cutting process. A high laser power is therefore required during cutting to achieve sufficient levels of heating in the material.

The present invention improves laser cutting performance by introducing a chemical additive to the assist gas that undergoes a chemical reaction in the hot laser-irradiated zone to produce a residue of elemental carbon (such as soot), which in turn enhances laser beam absorption.

Several authors have previously addressed modifying the composition of the assist gas to achieve better cutting performance, but none have suggested introducing an additive that would result in an overcoat of carbon on the surface to achieve better beam absorption. For example, U.S. Pat. No. 5,380,976 proposes using a mixture of a reactive and a reducing gas to achieve better cut quality in laser and plasma arc cutting processes of stainless steels, aluminum, and other metals. U.S. Pat. No. 6,521,864 describes a method of laser cutting structural and mild steels with a mixture of nitrogen and oxygen as the assist gas to reduce the oxidation of the cut edges. U.S. Pat. No. 6,891,126 shows that higher cutting speeds for metal materials can be achieved with an assist gas consisting of helium/argon, helium/nitrogen, and nitrogen/oxygen mixtures.

Unlike the method described herein, the subject matter in the abovementioned patents does not address enhancing the beam adsorption characteristics of the material, or rely on a residue formed in the hot zone for cutting performance improvement.

### DETAILED DESCRIPTION OF THE INVENTION

Currently most of the industrial laser cutting is accomplished with a flow (a jet) of gas impinging onto the surface of the material being cut simultaneously with a focused laser beam. This gas, known as assist gas in the industry, serves several functions: 1) It expels the molten material from the cut, 2) It protects the laser focusing optics from cutting debris and contamination, and 3) It cools the surface of the material, limiting the size of the heat-affected zone.

Assist gases commonly used in the industry include nitrogen, air, oxygen, argon, and helium. Their mixtures are also sometimes employed to improve cutting quality or speeds.

The present invention modifies the assist gas in a way that provides a surface darkening capability with the purpose of improving the absorption of the laser beam. In accordance with this invention, a carbon-containing chemical compound is added to the flow of the assist gas. This chemical compound is selected so that it either decomposes or reacts in the high-temperature heated zone created by the laser as it impinges on the material, and leaves a residue of elemental carbon that has improved beam absorption characteristics. The material surface covered with the carbon residue absorbs the beam more efficiently and is heated by the beam at a faster rate, thereby improving the cutting performance.

Alternatively, the elemental carbon residue thus formed in the hot zone may continue to be carried by the assist gas rather than stick to the material surface. In this case, the beam energy absorbed by the residue is first transferred to the assist gas in the form of heat, and the gas in turn transfers it to the material.

In the preferred embodiment of this invention, a carbon-containing organic compound is admixed to an inert assist gas such as nitrogen, argon or helium. Such organic compounds as acetylene (C₂H₂), ethylene (C₂H₄), other saturated or unsaturated hydrocarbons and aromatics (benzene C₆H₆, toluene C₆H₅CH₃) are examples of additives that can be used. If a compound if not a gas at room temperature (for example, hexane or toluene), then its gaseous vapor can be mixed with the inert gas.

The carbon-containing additive of the preferred embodiment decomposes in the hot zone irradiated by the focused laser beam and produces soot (a form of elemental carbon, possibly with impurities) that darkens the surface of the material being cut. Soot has excellent absorption characteristics for all industrially used lasers and serves to efficiently absorb the energy of the laser beam and transfer it to the material. The inert gas environment in the cut ensures that the carbon-containing additive forms soot rather than being oxidized to carbon monoxide (CO) or carbon dioxide (CO₂). Compounds that are relatively rich in carbon and relatively poor in hydrogen and oxygen (for example, acetylene C₂H₂) have a higher propensity for forming soot in a high-temperature inert gas environment, and are therefore more suited for this application.

If the additive is flammable, for safety purposes care must be taken to ensure that the concentration of the compound in the inert gas is low enough to avoid ignition after the assist gas stream comes into contact with air in the vicinity of the heated zone on the material. This means that the concentration of the additive must be maintained below the lower flammability limit (LFL) at all stages of mixing of the assist gas with air.

In the preferred embodiment, the assist gas containing a surface-darkening chemical additive is used in place of the regular assist gas with a laser cutting head of a commonly used design. The function of the cutting head is typically to focus the laser beam onto the material and deliver the jet of the assist gas to the cutting point. The particular design of the cutting head is immaterial to the present invention, other than that it must allow the use of an assist gas during cutting.

### BRIEF DESCRIPTION OF THE DRAWINGS

FIG. 1 shows diagrammatically the gas handling system of the preferred embodiment.

FIG. 2 shows diagrammatically the gas handling system of an alternative embodiment where the additive is a liquid.

### DETAILED DESCRIPTION OF THE DRAWINGS

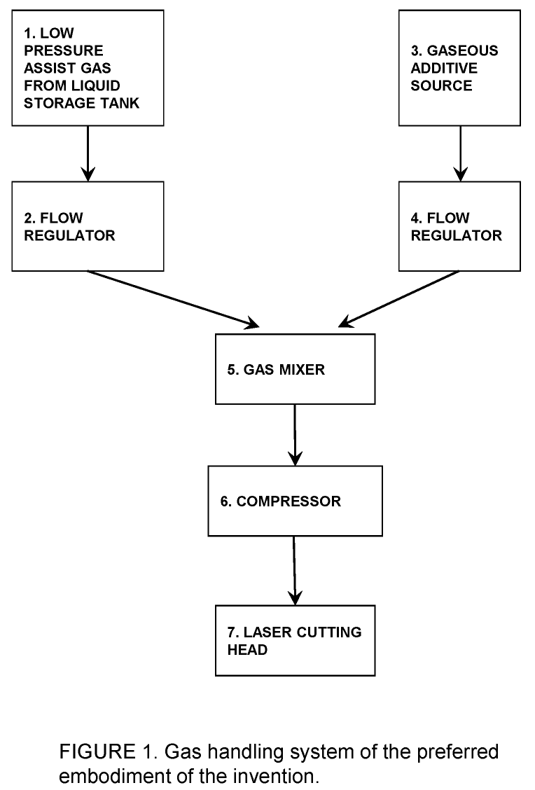

The gas handling system of the preferred embodiment is shown schematically in FIG. 1. The gas system serves to deliver the assist gas with the admixed additive to the cutting head. An inert gas 1 such as nitrogen is sourced from a liquid storage tank, usually at a pressure below that required for the cutting process. A flow regulator 2 determines the flow rate of the inert gas. Gaseous additive 3 is sourced, for instance, from a compressed gas cylinder. Another flow regulator 4 controls the flow rate of the additive. If the additive is not gaseous at room temperature, its vapor in an inert carrier gas can be used instead. The additive flow and the inert gas flow are mixed in a gas mixer 5. The mixer outputs the resulting flow to a compressor 6 that increases the gas pressure to that required in the cutting process. The assist gas containing the additive is then directed to the cutting head 7.

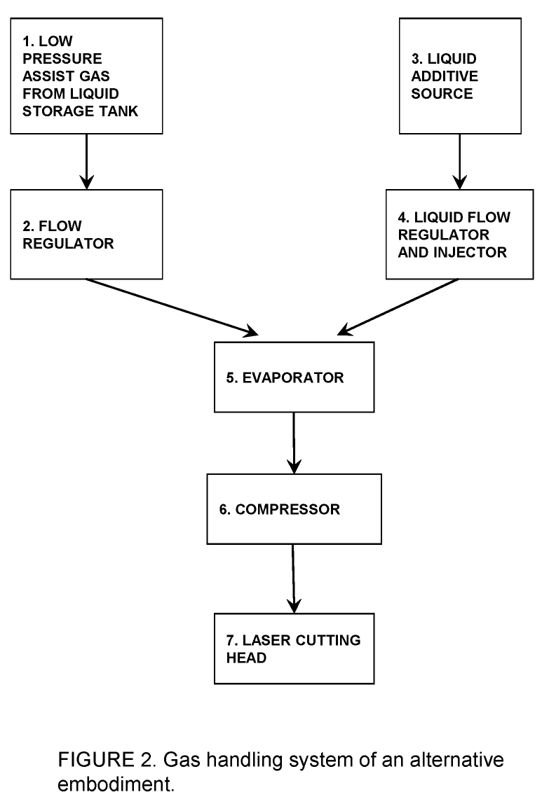

In an alternative embodiment, the chemical additive is a liquid at ambient conditions (for example benzene, C₆H₆), and the gas handling system is modified accordingly, as shown in FIG. 2. The inert gas 1 from the liquid storage tank is directed through a flow regulator 2 to an evaporator 5 (which may be heated) rather than a gas mixer. The liquid additive 3 is fed into a liquid flow regulator and injector 4, which in turn feeds it into the evaporator 5. After the liquid is vaporized into the inert gas in the evaporator 5, the vapor-containing assist gas proceeds to the compressor 6 and the cutting head 7, as in the preferred embodiment. Care must be taken to ensure that the condensation of the additive does not occur anywhere along the path of the modified assist gas.

### CITATIONS

1. U.S. Pat. No. 5,380,976. Process for high quality plasma arc and laser cutting of stainless steel and aluminum.
2. U.S. Pat. No. 6,521,864. Method and apparatus for the laser cutting of mild steel or structural steel with a multifocus optical component.
3. U.S. Pat. No. 6,891,126. High-speed laser cutting method with adapted gas.

What is claimed is:

1. A method of laser cutting comprising:
directing a laser beam onto a material being cut, thereby producing a heated zone on said material being cut;
directing a flow of gas onto said heated zone, wherein said flow of gas contains a chemical additive which produces a form of elemental carbon when in contact with said heated zone.

2. The method according to claim 1 wherein said form of elemental carbon is soot.

3. The method according to claim 1 wherein said chemical additive is selected from the group consisting of hydrocarbons and halogenated hydrocarbons.

4. The method according to claim 1 wherein said chemical additive is selected from the group consisting of benzene, toluene, acetylene, ethylene, propene, propane, butane, and dichloromethane.
